(19) United States
(12) Patent Application Publication
(10) Pub. No.: US 2016/0327936 A1
(43) Pub. Date: Nov. 10, 2016

(54) GLOBAL OPTIMAL SOLUTION FOR A PRACTICAL SYSTEM MODELED AS A GENERAL CONSTRAINED NONLINEAR OPTIMIZATION PROBLEM

(71) Applicant: Bigwood Technology, Inc., Ithaca, NY (US)

(72) Inventors: Hsiao-Dong Chiang, Ithaca, NY (US); Bin Wang, Ithaca, NY (US)

(21) Appl. No.: 14/703,671

(22) Filed: May 4, 2015

(51) Int. Cl. G05B 19/408

(52) U.S. Cl. CPC G05B 19/4083; G05B 2219/32291

(57) ABSTRACT

A global optimizer system optimizes an objective function of an industrial system subject to a set of constraint functions. The objective function and the constraint functions are modeled as a constrained nonlinear optimization problem. The global optimizer system computes a global optimal solution to the constrained nonlinear optimization problem by performing the steps of: (a) constructing a dynamical system associated with optimality conditions of the constrained nonlinear optimization problem; (b) starting from an initial point, performing a deterministic, tier-by-tier dynamical search on the dynamical system and obtaining a complete set of stable equilibrium points (SEPs) of the dynamical system; (c) identifying a complete set of local optimal solutions to the constrained nonlinear optimization problem from the complete set of SEPs; and (d) identifying the global optimal solution to the constrained nonlinear optimization problem from the complete set of local optimal solutions.

### TECHNICAL FIELD

Embodiments of the invention pertain to the field of modeling and optimization.

### BACKGROUND

Many theoretical and practical problems can be formulated as a general constrained nonlinear optimization problem of the form:

$$\begin{matrix}min & f ( x ) \\ s . t & {h}_{i} ( x ) = 0 , i ∈ ℰ = \{ 1 , … , {n}_{ℰ} \} \\ & {g}_{j} ( x ) \leq 0 , j ∈ 𝒥 = \{ 1 , … , {n}_{𝒥} \}\end{matrix} \qquad ( P .1 )$$

where the objective function ƒ(x), the equality constraints hᵢ(x), i∈ε={1, . . . , n_{ε}} and the inequality constraints gᵢ(x), j∈ [symbol] ={1, . . . , n [symbol] } can be nonlinear and are all twice differentiable, that is, they all belong to C²:Rⁿ→R.

Solving the optimization problem (P.1) and finding the global optimal solution have many industrial applications in different areas. The optimal power flow (OPF) problem in electric power systems is one example. In solving the OPF problem, the objective function ƒ(x) can be the system total production cost or the system total power losses; and the equality constraints h(x) are the power balance equations that must be complied because of underlying physical laws for operating the power network; and the inequality constraints g(x) include the physical and operational limits imposed on the system equipment operating conditions or states to ensure a secure operation of the power network; and the optimization variables x are quantities associated with devices of the power network that can be adjusted, such as the power outputs by generators, voltage settings at system nodes, amount of shunt capacitors deployed, and tap positions of transformers. A tank design for a multi-product plant in chemical engineering is another example. In solving the tank design problem, the objective function ƒ(x) can be the sum of the production cost per ton per product produced; and the optimization variables x are quantities of products; and the equality constraints h(x) consist of balance of materials used in production; and the inequality constraints g(x) include lower and upper bounds on volume flows and inventories of products.

Because of the nonlinearity of the objective and constraint functions, a real world problem usually contains many local optimal solutions, and their objective values can differ significantly to each other; therefore, obtaining a global optimal solution to (P.1) is of primary importance in real applications. On the other hand, the constraint set of (P.1) defines the following feasible set:

S={x∈Rⁿ:hᵢ(x)=0,i∈ε,gⱼ(x)≦0,j∈ [symbol] },

which can be any closed subset of Rⁿ, and its structure can be very complex. The feasible set S is usually non-convex and disconnected; i.e., it is composed of several disjoint and path-connected feasible regions. As a result, the existence of multiple local optimal solutions, the number of which is typically unknown, to the optimization problem (P.1) can be due to not only the nonlinearity of the objective function, but also the complexity of the feasible regions. Since locating each connected feasible region of the set S is in itself a difficult task, it is a challenge to find the global optimal solution to the nonlinear optimization problem (P.1).

There has been a wealth of research efforts focused on developing effective and robust methods to solve the optimization problem (P.1). Existing optimization methods for solving (P.1) can be roughly categorized into two types. The first type is called local methods, such as trust-region methods, sequential quadratic programming (SQP), and interior point methods (IPM). These methods usually solve first-order necessary conditions numerically to find local optimal solutions to (P.1). They are generally deterministic and fast to compute a local optimal solution, but can be entrapped in the local optimal solution. The other type is called global methods, such as genetic algorithms (GA), particle swarm optimization (PSO) and simulated annealing (SA). These methods generally use stochastic heuristics to escape from a local optimal solution and directly search for an approximation to the global optimal solution to (P.1). Global methods are good at locating promising areas, but they are generally computationally demanding to find a good approximation to the global optimal solution.

Prior work related to the constrained global optimization is described in J. Lee and H. D. Chiang, A dynamical trajectory-based methodology for systematically computing multiple optimal solutions of general nonlinear programming problems, IEEE Trans. Autom. Control, vol. 49, pp. 888-899, 2004, the complete disclosure of which is hereby incorporated herein by reference. This publication presents a two-phase optimization procedure to tackle the optimization problem (P.1), where a particular nonlinear dynamical system is constructed in the first phase to locate multiple feasible components of (P.1) and another particular nonlinear dynamical system is constructed in the second phase for finding multiple local optimal solutions to (P.1) within each feasible component.

The idea of computing exit points of a class of nonlinear systems is described in U.S. Pat. No. 5,483,462, On-line Method for Determining Power System Transient Stability, issued to Hsiao-Dong Chiang on Jan. 9, 1996, the complete disclosure of which is hereby incorporated herein by reference.

The idea of computing all local optimal solutions to unconstrained continuous and discrete optimization problems is described in U.S. Pat. No. 7,050,953, Dynamical Methods for Solving Large-Scale Discrete and Continuous Optimization Problems, issued to Hsiao-Dong Chiang and Hua Li on May 23, 2006, the complete disclosure of which is hereby incorporated herein by reference.

The idea of computing all local optimal solutions to a constrained nonlinear optimization problem with a two-phase methodology is described in U.S. Pat. No. 7,277,832, Dynamical Method for Obtaining Global Optimal Solution of General Nonlinear Programming Problems, issued to Hsiao-Dong Chiang on Oct. 2, 2007, the complete disclosure of which is hereby incorporated herein by reference.

### SUMMARY

A method is provided for obtaining a global optimal solution to general constrained nonlinear optimization problems. The method includes the steps of: (i) finding, in a deterministic and tier-by-tier manner, all stable equilibrium points (SEPs) of a nonlinear dynamical system associated with the optimality conditions of the optimization problem; (ii) finding from the SEPs all local optimal solutions to the optimization problem; and (iii) finding from the local optimal solutions a global optimal solution to the optimization problem.

A practical numerical method is also provided for effectively and reliably computing all local optimal solutions, and finding from which a global optimal solution to large-scale constrained nonlinear optimization problems. The practical numerical method includes the steps of: (i) constructing a nonlinear dynamical system associated with the Karush-Kuhn-Tucker (KKT) conditions of the optimization problem; (ii) computing a comprehensive set of SEPs of the dynamical system through incorporating a local optimizer, namely, the interior point method (IPM), with an exit-point based multi-tier dynamical search; (iii) identifying a comprehensive set of local optimal solutions to the optimization problem among the set of stable equilibrium points; and (iv) identifying the global optimal solution among the set of local optimal solutions.

According to one embodiment of the invention, a method performed by an optimization system is provided for optimizing an objective function of an industrial system subject to a set of constraint functions. The method includes: modeling the objective function and the constraint functions as a constrained nonlinear optimization problem; and computing a global optimal solution to the constrained nonlinear optimization problem by performing the steps of: (a) constructing a dynamical system associated with optimality conditions of the constrained nonlinear optimization problem; (b) starting from an initial point, performing a deterministic, tier-by-tier dynamical search on the dynamical system and obtaining a complete set of SEPs of the dynamical system; (c) identifying a complete set of local optimal solutions to the constrained nonlinear optimization problem from the complete set of SEPs; and (d) identifying the global optimal solution to the constrained nonlinear optimization problem from the complete set of local optimal solutions.

In another embodiment, a non-transitory computer readable storage medium includes instructions that, when executed by a computer system, cause the computer system to perform the aforementioned method for optimizing an objective function of an industrial system subject to a set of constraint functions.

In yet another embodiment, a system is provided for optimizing an objective function of an industrial system subject to a set of constraint functions. The system includes: a memory to store a global optimizer module; and one or more processors coupled to the memory. The one or more processors are adapted to execute operations of the global optimizer module to: model the objective function and the constraint functions as a constrained nonlinear optimization problem; and compute a global optimal solution to the constrained nonlinear optimization problem. The one or more processor further are adapted to (a) construct a dynamical system associated with optimality conditions of the constrained nonlinear optimization problem; (b) start from an initial point, performing a deterministic, tier-by-tier dynamical search on the dynamical system and obtaining a complete set of SEPs of the dynamical system; (c) identify a complete set of local optimal solutions to the constrained nonlinear optimization problem from the complete set of SEPs; and (d) identify the global optimal solution to the constrained nonlinear optimization problem from the complete set of local optimal solutions.

### BRIEF DESCRIPTION OF THE DRAWINGS

Embodiments are illustrated by way of example and not limitation in the Figures of the accompanying drawings:

FIG. 1 illustrates a system that performs a dynamical method for solving constrained nonlinear optimization problems according to one embodiment of the invention.

FIG. 2 is a flowchart illustrating a dynamical search method according to one embodiment of the invention.

FIG. 3 is a flowchart illustrating a dynamical method that incorporates an interior point method for solving constrained nonlinear optimization problems according to one embodiment of the invention.

FIG. 4A is a flowchart illustrating a method for constructing a KKT dynamical system associated with the optimality conditions of a constrained nonlinear optimization problem according to one embodiment of the invention.

FIG. 4B is a flowchart illustrating a method for constructing the KKT dynamical system associated with the optimality conditions of a constrained nonlinear optimization problem according to another embodiment of the invention.

FIG. 5 is a flowchart illustrating a post-processing method for finding a complete set of local optimal solutions to an optimization problem from a complete set of stable equilibrium points (SEPs) of a dynamical system associated with the optimality conditions of an optimization problem according to another embodiment of the invention.

FIG. 6 is a schematic illustrating six local optimal solutions to an example constrained nonlinear optimization problem.

FIG. 7 is a schematic illustrating six SEPs of a nonlinear dynamical system that correspond to the six local optimal solutions in the example constrained nonlinear optimization problem of FIG. 6.

FIG. 8 is a schematic illustrating an initial point and its associated stability region and SEP in the example constrained nonlinear optimization problem of FIG. 6.

FIG. 9 is a schematic illustrating a tier-1 search in the example constrained nonlinear optimization problem of FIG. 6.

FIG. 10 is a schematic illustrating a tier-2 search in the example constrained nonlinear optimization problem of FIG. 6.

FIG. 11 is a schematic illustrating a tier-3 search in the example constrained nonlinear optimization problem of FIG. 6.

FIG. 12 is a schematic illustrating six local optimal solutions and a global optimal solution that are found among the seven SEPs in the example constrained nonlinear optimization problem of FIG. 6.

FIG. 13 is a schematic illustrating SEPs, exit points and stability region points that are found in the example constrained nonlinear optimization problem of FIG. 6.

FIG. 14 is a flow diagram illustrating a method of an optimization system according to one embodiment of the invention.

FIG. 15 is a block diagram illustrating an example of an optimization system according to one embodiment of the invention.

FIG. 16 is a block diagram illustrating an example of a computer system according to one embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

One reliable way to find the global optimal solution to (P.1) is to first find all local optimal solutions, and then find the global optimal solution from the local optimal solutions. To this end, it is desirable to develop a deterministic method that not only escapes from a local optimal solution, but also computes multiple local optimal solutions to the optimization problem (P.1).

Embodiments of the invention provide a systematic and deterministic methodology for finding all local optimal solutions to general constrained optimization problems of the form (P.1). For these optimization problems, one distinguishing feature of the methodology is that it systematically finds all of the local optimal solutions to a constrained nonlinear optimization problem whether or not its feasible region is disconnected. In particular, the methodology finds all of the local optimal solutions in a single phase, by constructing a nonlinear dynamical system using optimality conditions associated with the optimization problem. In this construction, all stationary points of the optimality conditions, which are critical points of the optimization problem and contain all its local optimal solutions, have a one-to-one mapping to the set of stable equilibrium points (SEPs) of the dynamical system. Therefore, by systematically finding all SEPs of the dynamical system, the methodology is able to find all local optimal solutions to the optimization problem (P.1). Then the global optimal solution can be found from these local optimal solutions.

Embodiments of the invention improve the existing methods in at least the following aspects:

1) A class of nonlinear dynamical systems is provided for solving general constrained nonlinear optimization problems. The trajectories of these dynamical systems can be exploited to develop numerical methods for finding a complete set of local optimal solutions and the global optimal solution. Moreover, this class of nonlinear dynamical systems and the trajectories of the systems can also be used to solve unconstrained nonlinear optimization problems.

2) A single-phase, dynamical trajectory-based method is provided. This method can incorporate any existing local optimizer to find a complete set of local optimal solutions and the global optimal solution to general constrained nonlinear optimization problems. Moreover, this method is a unified method that is applicable to both unconstrained and constrained nonlinear optimization problems.

TRUST-TECH Guided Methods for Constrained Nonlinear Global Optimization. As mentioned before, a reliable way to find the global optimal solution of the optimization problem (P.1) is to first find all of the local optimal solutions, and then find the global optimal solution from the local optimal solutions. This can be done through a procedure which conceptually includes the following two tasks:

Task 1: Start from an arbitrary point and compute a local optimal solution to the optimization problem (P.1).

Task 2: Move away from the local optimal solution and approach another local optimal solution of the optimization problem (P.1).

TRUST-TECH based methods accomplish these two tasks using the trajectories of a particular class of nonlinear dynamical systems. More specifically, TRUST-TECH based methods accomplish the tasks by the following steps:

i) Construct a dynamical system such that there is a one-to-one correspondence between the set of local optimal solutions to the optimization problem (P.1) and the set of SEPs of the dynamical system; in other words, for each local optimal solution to the problem (P.1), there is a distinct SEP of the dynamical system that correspond to it.

ii) Find all SEPs of the constructed dynamical system, and then find a complete set of local optimal solutions to the problem (P.1) among the complete set of SEPs.

iii) Find the global optimal solution from the complete set of local optimal solutions.

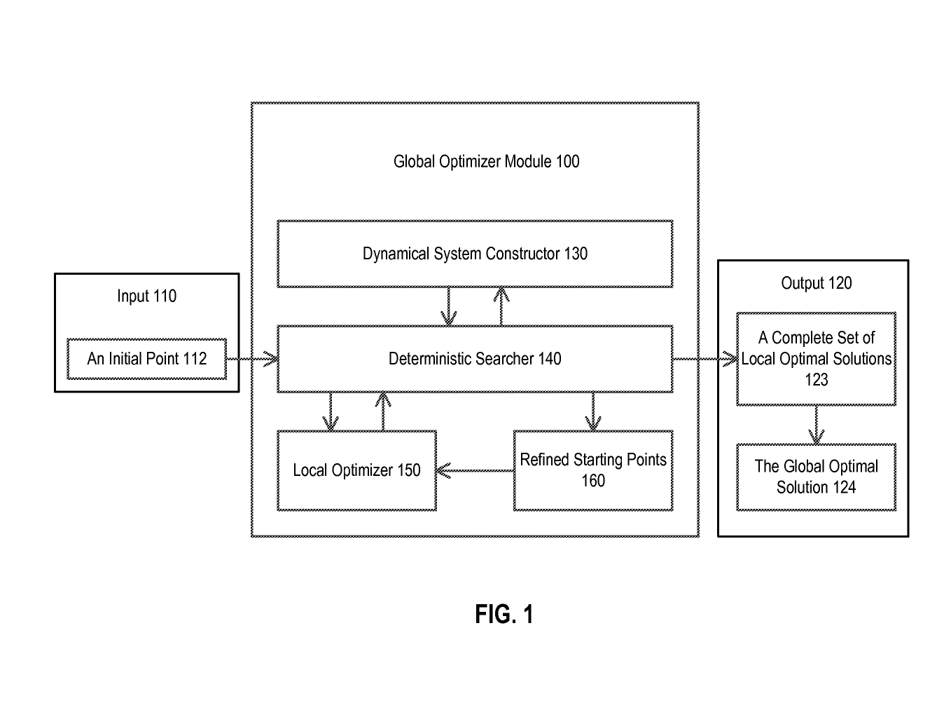

FIG. 1 illustrates a system that performs a dynamical method for obtaining a global optimal solution to a general constrained nonlinear optimization problem of the form (P.1) according to one embodiment of the invention. In one embodiment, the system is a global optimizer 100 for constrained nonlinear optimization problem. The global optimizer 100 receives an input 110, which is an arbitrary initial point 112, and generates an output 120, which includes a complete set of local optimal solutions 123 from which a global optimal solution 124 can be found. The global optimizer 100 includes a dynamical system constructor 130 that constructs a dynamical system associated with the optimality conditions of the optimization problem (P.1), a deterministic searcher 140 that performs a deterministic, tier-by-tier dynamical search. In one embodiment, the deterministic searcher 140 performs the following operations on the constructed dynamical system: a) computing SEPs from starting points by incorporating existing local optimizers 150 into the search, and b) escaping from stability regions of the SEPs and producing refined starting points 160 to avoid entrapment in local optimal solutions. The deterministic searcher 140 obtains a complete set of SEPs of the dynamical system. The global optimizer 100 then identifies the complete set of local optimal solutions 123 to the optimization problem from the set of SEPs, and identifies the global optimal solution 124 to the optimization problem from the set of local optimal solutions 123 to the optimization problem.

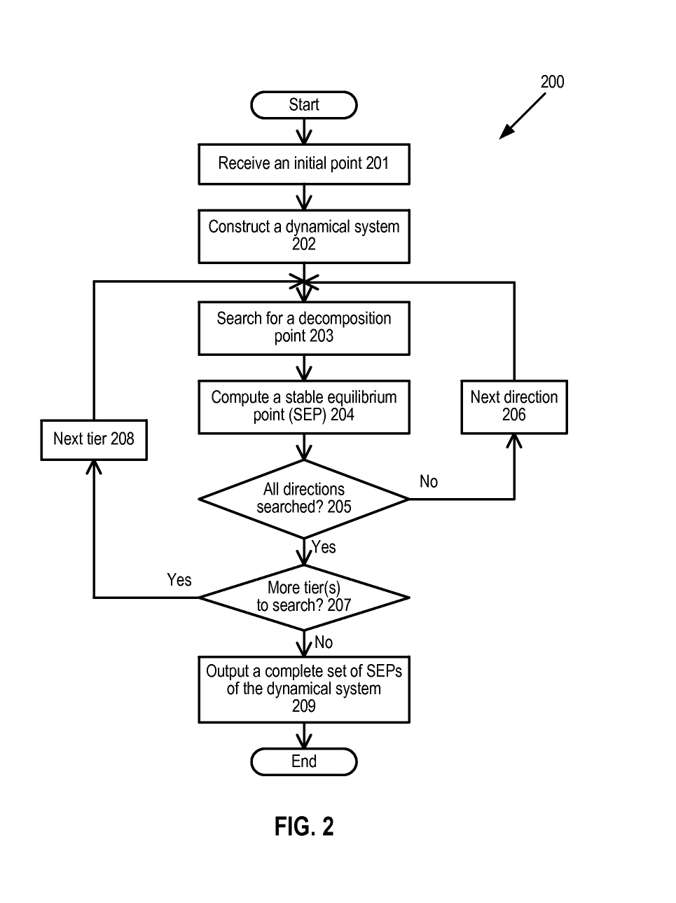

FIG. 2 illustrates a dynamical search method 200 performed by the deterministic searcher 140 of FIG. 1 for obtaining a global optimal solution to the optimization problem (P.1) according to one embodiment. The method 200 includes the following steps:

(a) Receive an initial point x₀ (block 201).

(b) Construct a dynamical system associated with the optimality conditions of the optimization problem (P.1) (block 202).

(c) Apply a local optimizer using the initial point x₀ to compute an initial SEP xₛ⁰ of the dynamical system

(d) Set i=0, Vₛ={xₛ⁰}, V_{new}ⁱ={xₛ⁰}.

(e) Set V_{new}ⁱ⁺¹=Ø.

For each SEP in V_{new}ⁱ, the method 200 further includes the following steps (f) through (l):

(f) Compute a set of search directions {Sᵢ^{j}, j=1, 2, . . . , mᵢ}, and set j=1.

(g) Search for a dynamic decomposition point x_{d}^{j} along the search direction Sᵢ^{j} (block 203). If a dynamic decomposition point x_{d}^{j} is found, proceed to step (h); otherwise proceed to step (k). A dynamical decomposition point (DDP) is the first type-1 unstable equilibrium point whose stable manifold is hit by the search path at the exit point. A type-1 unstable equilibrium point is an equilibrium point at which the system Jacobian matrix has one and only one eigenvalue with a positive real part (all other eigenvalues have negative real parts).

(h) Set x₀^{j}=x_{d}^{j}+ε(x_{d}^{j}−xₛⁱ), where ε is a small number. Compute a new initial point xᵣ^{j}, which is in a next-tier stability region, by integrating the trajectory of the dynamical system for a few steps starting from x₀^{j} (block 204).

(i) Apply a local optimizer using the initial point xᵣ^{j} to compute an SEP xₛ^{j} (block 204).

(j) Check whether xₛ^{j}∈Vₛ. If xₛ^{j} ∈Vₛ, then proceed to step (k); otherwise, set Vₛ=Vₛ ∪{xₛ^{j}} and V_{new}ⁱ⁺¹=V_{new}ⁱ⁺¹∪{xₛ^{j}} and proceed to step (k).

(k) Set j=j+1 and check whether j<=mᵢ (i.e., whether all directions are searched) (block 205). If j<=mᵢ (block 206), proceed to step (g); otherwise, proceed to step (l).

(l) Check if V_{new}ⁱ⁺¹ is non-empty (block 207). If V_{new}ⁱ⁺¹ is non-empty, then set i=i+1 (block 208) and proceed to step (e); otherwise, proceed to step (m).

(m) Output the complete set of SEPs of the dynamical system (block 209).

Interior Point Methods (IPMs). IPMs have been an important research area in optimization since the development of the Simplex method. In particular, these methods provide an attractive alternative to active set strategies in handling problems with large numbers of inequality constraints. Over the past decades, there has also been a better understanding of the convergence properties of IPMs. Efficient algorithms have been developed with desirable global and local convergence properties.

An IPM includes three basic elements: (i) a barrier method to handle inequality constraints; (ii) a Lagrangian method to handle equality constraints; and (iii) an improved Newton method to solve the set of nonlinear equations which originates from the Karush-Kuhn-Tucker (KKT) optimality conditions. In order to solve the optimization problem (P.1), an IPM firstly applies the Fiacco-McCormick barrier method and adds slack variables to transform the optimization problem (P.1) into the following equality-constrained optimization problem:

$$min f ( x ) - μ {\sum }_{j = 1}^{{n}_{𝒥}} ln {u}_{j}$$

$$\begin{matrix}s . t . & {h}_{i} ( x ) = 0 \\ & {g}_{j} ( x ) + {u}_{j} = 0 \\ & {u}_{j} \geq 0\end{matrix} .$$

Then the following augmented Lagrangian function can be defined:

L_{g}=ƒ(x)−y^{T}h(x)−w^{T}(g(x)+u)−μ [symbol] ln uⱼ,

where, yᵢ and wⱼ are Lagrangian multipliers for equality and inequality constraints, respectively, and uⱼ are slack variables. The first-order necessary conditions, namely the KKT conditions (also referred to as the first-order KKT optimality conditions), associated with the Lagrangian f unction L_{g} are given as follows:

Lₓ=∇ƒ(x)−∇ₓ^{T}h(x)y−∇ₓ^{T}g(x)w=0

L_{y}=h(x)=0

L_{w}=g(x)+u=0

Lᵤ=UWE+μE=0 (E.1)

where U=diag(u₁, u₂, . . . , uₙ [symbol] ), W=diag(w₁, w₂, . . . , wₙ [symbol] ) and E=[1, 1, . . . , 1]^{T}. The following two decomposed linear equations are obtained when applying the Newton method to solve the above nonlinear equations (E.1):

$$\begin{matrix}[ \begin{matrix}H & {∇}_{x} h ( x ) \\ {∇}_{x}^{T} h ( x ) & 0\end{matrix} ] [ \begin{matrix}∇ x \\ ∇ y\end{matrix} ] = [ \begin{matrix} \\ - {L}_{y}\end{matrix} ] \\ and & ( E .2 ) \\ [ \begin{matrix}U & W \\ 0 & I\end{matrix} ] [ \begin{matrix}Δ w \\ Δ u\end{matrix} ] = [ \begin{matrix} \\ - {L}_{w} - {∇}_{x}^{T} g ( x ) Δ x\end{matrix} ] \\ where \\ H = {∇}_{x}^{2} f ( x ) + {∇}_{x}^{2} h ( x ) y + {∇}_{x}^{2} g ( x ) {U}^{- 1} W {∇}_{x}^{T} g ( x ) \\ = {L}_{x} + {∇}_{x} g ( x ) [ {U}^{- 1} ( - {WL}_{w} ) ] \\ = UWE + μ E + Δ u Δ w . & ( E .3 )\end{matrix}$$

Observing equations (E.2) and (E.3), it is impossible to solve (E.2) and (E.3) directly because the right-hand side includes unknown high-order deviations ΔuΔw. In order to solve this problem, the predictor-corrector interior point method was proposed, in which a predictor step and a corrector step are needed at each iteration. Because the predictor step and the corrector step share the same coefficient matrix with two different right-hand sides, only one LU factorization is needed. The predictor-corrector interior point method is composed of the following steps:

1) Initialization: Set iteration number k=0, give the initial values of state variables x⁰, slack variables u⁰, Lagrange multipliers y⁰, w⁰.

2) Let μ=0, ΔuΔw=0, solve the linear equations (E.2) to obtain the affine directions Δx_{of} and Δy_{of}, then obtain Δu_{of} and Δw_{of} by back substitution of (E.3).

3) Compute step sizes α_{ofp} and α_{ofd}, and modify complementary gaps, GAP and GAP_{of}, update the barrier parameter:

$${α}_{ofp} = min \{ 0.9995 {min}_{i} ( - \frac{{u}_{i}}{Δ {u}_{ofi}} , Δ {u}_{ofi} < 0 ) , 1 \}$$

$${α}_{ofd} = min \{ 0.995 {min}_{i} ( - \frac{{w}_{i}}{Δ {w}_{ofi}} , Δ {w}_{ofi} > 0 ) , 1 \}$$

$$GAP = - {u}^{T} w$$

$${GAP}_{of} = - {( u + {α}_{ofp} Δ {u}_{of} )}^{T} ( w + {α}_{ofd} Δ {w}_{of} )$$

$${μ}_{of} = min \{ {( \frac{{Gap}_{of}}{GAP} )}^{2} , 0.1 \} \frac{{GAP}_{of}}{2 r} .$$

4) Set μ=μ_{of}, ΔuΔw=Δu_{of}Δw_{of}, and resolve the linear equations (E.1) using the same LU factorization matrix obtained in step 2 to obtain centering-corrector directions Δx and Δy. Then obtain Δu and Δw by back substitution of (E.2), and update all the variables:

$${α}_{p} = min \{ 0.9995 {min}_{i} ( - \frac{{u}_{i}}{Δ {u}_{i}} , Δ {u}_{i} < 0 ) , 1 \}$$

$${α}_{d} = min \{ 0.9995 {min}_{i} ( - \frac{{w}_{i}}{Δ {w}_{i}} , Δ {w}_{i} > 0 ) , 1 \}$$

$$x = x + {α}_{p} Δ x$$

$$I = I + {α}_{p} Δ I$$

$$u = u + {α}_{p} Δ u$$

$$y = y + {α}_{d} Δ y$$

$$z = z + {α}_{d} Δ z$$

$$w = w + {α}_{d} Δ w .$$

5) Compute complementary gap GAP=−u^{T}w. If GAP and maximal absolute power flow mismatch are less than the given precision, or the maximal iteration is reached, then stop; otherwise, go to step 2.

Despite their nice numerical efficiency, IPMs are a class of local optimization methods. In other words, from a starting point, IPMs can only compute a single local optimal solution to the optimization problem (P.1). Same as other types of local methods, there is no mechanism available in IPMs to escape from a local optimal solution and to approach another local optimal solution.

The TRUST-TECH Guided IPM. According to embodiments of the invention, a TRUST-TECH guided IPM (TT-IPM) method is provided that integrates the concept of TRUST-TECH into IPMs. TT-IPM enables the computation of all local optimal solutions to the nonlinear optimization problem (P.1).

A principal task in developing TT-IPM is to design a nonlinear dynamical system whose trajectories can be explored to perform Task 1 and Task 2 mentioned above. The central idea in designing such a nonlinear dynamical system is that all the local optimal solutions to the optimization problem (P.1) corresponds with all the SEPs of the nonlinear dynamical system. In particular, every local optimal solution to the optimization (P.1) corresponds with an SEP of the nonlinear dynamical system.

As has been shown in previous section, IPM solves the optimization problem (P.1) by finding a stationary point of the penalized Lagrange function

L(x,y,z,s,μ)=ƒ(x)+y^{T}h(x)+z^{T}(g(x)+s)−μΣᵢ₌₁ [symbol] ln sᵢ. (E.4)

Specifically, a stationary point of (E.4) can be obtained by solving the KKT optimality conditions (i.e., first order necessary conditions), which can be represented as the following system of nonlinear equations:

Lₓ=∇ƒ(x)−∇ₓ^{T}h(x)y−∇ₓ^{T}g(x)z=0

L_{y}=h(x)=0

L_{z}=g(x)+s=0.

Lₛ=Zs−μe=0 (E.5)

As μ→0, the solution of the system of nonlinear equations (E.5) approaches a critical point x̅ of the nonlinear optimization problem (P.1) with Lagrange multipliers (y̅, z̅).

The major difficulty in solving (E.5) is mainly related to the complementarity conditions Lz and Ls. Therefore, instead of solving the system of nonlinear equations (E.5) directly until μ=0, a nonlinear complementary approach can be introduced to handle the complementarity conditions Lz and Ls. In this construction, a critical point of the optimization problem (P.1) can be obtained by solving the following system of nonlinear equations

Lₓ=∇ƒ(x)−∇ₓ^{T}h(x)y−∇ₓ^{T}g(x)z=0

L_{y}=h(x)=0

L_{z}=g(x)+s=0

Ψₛ=ψ(z,s)=0 (E.6)

where the nonlinear complementarity function ψ:R²→R holds the property of

ψ(z,s)=0 [symbol] zs=0,z≧0,s≧0.

Examples of nonlinear complementarity functions include

$$ψ ( z , s ) = z + s - \sqrt{{z}^{2} + {s}^{2}}$$

$$ψ ( z , s ) = \frac{1}{2} min \{ z , s \}$$

$$ψ ( z , s ) = \frac{1}{2} ( {z}^{2} {s}^{2} + {min}^{2} \{ 0 , z \} + {min}^{2} \{ 0 , δ \} ) .$$

In order to realize TT-IPM, in one embodiment of the present invention, a KKT dynamical system is constructed. The KKT dynamical system has a vector field associated with critical points of the optimization problem (P.1), and can be defined by the following formulation:

\dot{w}=F(w). (E.7)

In another embodiment of the present invention, a KKT dynamical system having a vector field associated with critical points of the optimization problem (P.1) is defined as follows:

\dot{w}=−∇^{T}F(w)·F(w), (E.8)

where w is the vector of variables of the system of nonlinear equations, and includes all the primal and dual variables for the optimization problem (P.1). F(w) is the function of the system of nonlinear equations (E.5) or the modified system of nonlinear equations (E.6).

In these constructions, the state variables of the system are w=(x, y, z, s)^{T}. In one embodiment, the nonlinear dynamical system equation (E.7) can be constructed using the gradient vector of the Lagrange function (E.4), that is, F(w)=(Lₓ, L_{y}, L_{z}, Lₛ)^{T}. In another embodiment of the present invention, the nonlinear dynamical system equation (E.7) or (E.8) can be constructed using the nonlinear complementarity formulation (E.6), that is, F(w)=(Lₓ, L_{y}, L_{z}, Ψₛ)^{T}.

Based on these constructions, the TT-IPM method can be numerically implemented via the following stages:

Stage 1: Approach an SEP of the KKT dynamical system, which is a critical point of the optimization problem (P.1).

Stage 2: Move from the SEP to a DDP (in order to escape from the critical point).

Stage 3: Approach another SEP of the KKT dynamical system, which is another critical point of the optimization problem (P.1), by moving along the unstable manifold of the DDP.

Stage 1 can be implemented by following the trajectory of the KKT dynamical system starting from any initial point. Stage 3 can be implemented by following the trajectory starting from an initial point, which is close to the DDP but outside the stability region, until it approaches another SEP of the KKT dynamical system, which is another critical point of the optimization problem (P.1).

Characterization of the KKT dynamical system. A trajectory of the KKT dynamical system (E.8) is used to systematically locate the set of critical points to the optimization problem (P.1) in a deterministic manner. The global dynamical behaviors of the KKT dynamical system (E.8) play a central role in finding the set of critical points of the optimization problem (P.1).

Assumption 1: For any bounded, closed interval [a,b] and for any relatively closed subset K of (L⁻¹([a, b])\E_{L}) in S, we have inf{∥∇^{T}F(w)·F(w)∥x∈K}>0, where, E_{L}={w∈R^{m}:∇^{T} F(w)·F(w)=0} and m=n+2n_{ε}+2n [symbol] .

It is noted that if each path-connected feasible component of M is compact, then Assumption 1 always holds. The constraint components of many practical optimization problems are compact, hence, Assumption 1 usually holds.

The global behavior of nonlinear dynamical systems can be very complicated. Their trajectories can behave unbounded or/and bounded but complicated such as almost periodic trajectory, or even chaotic motions. The global behavior of the KKT dynamical system (E.8) is very simple: every trajectory converges to an equilibrium point. There is no complicated behaviors such as closed orbit (i.e., limit cycles) and chaotic motion that can exist in the KKT dynamical system (E.8). Note that a nonlinear dynamical system is said to be completely stable if every trajectory of the system converges to one of its equilibrium points.

Theorem 1.1 (Completely Stable): If the optimization problem (P.1) satisfies Assumption 1, then the corresponding KKT dynamical system (E.8) is completely stable.

Theorem 1.2 (Equilibrium Points and Critical Points): If the optimization problem (P.1) satisfies Assumption 1 and all the equilibrium points of the KKT dynamical system (E.8) is hyperbolic and finite in number, then each critical points of the optimization problem (P.1) is an SEP of the KKT dynamical system (E.8). Conversely, if x̅ is an SEP of the KKT dynamical system (E.8), then x̅ is an isolated local minimum of the following minimization problem

$${min}_{w ∈ {R}^{m}} \frac{1}{2} {‖ F ( w ) ‖}^{2} . \qquad ( E .9 )$$

Theorem 1.2 provides a theoretical basis for the TT-IPM method. It asserts that each critical point of the optimization problem (P.1) can be located via the stable equilibrium point of the KKT dynamical system (E.8).

Theorem 1.3 (Characterization of Quasi-Stability Boundary):

Let Aₚ(xₛ) be the quasi-stability region of xₛ of the KKT dynamical system (E.8) and let xᵢ, i=1, 2, . . . , be all the DDPs of xₛ. If the system satisfies the following conditions: i) the equilibrium points on the quasi-stability boundary ∂Aₚ(xₛ) are hyperbolic and finite in number, and ii) the stable and unstable manifolds of the equilibrium points on ∂Aₚ(xₛ) satisfy the transversality condition; then the quasi-stability boundary ∂Aₚ(xₛ) is the union of the closure of the stable manifolds of xᵢ. In other words, ∂Aₚ(xₛ)=∪ₓ_{ᵢ}_{∈∂A}_{ₚ}₍ₓ_{ₛ}₎W̅^̅{̅s̅}̅(̅x̅ᵢ̅)̅.

Next, a dynamical relationship is derived between an SEP and a DDP lying on the quasi-stability boundary of the SEP in the following theorem.

Theorem 1.4 (DDPs and SEPs)

Let Aₚ(xₛ) be the quasi-stability region of xₛ of the KKT dynamical system (E.8) that satisfies the following conditions: i) the equilibrium points on quasi-stability boundaries are hyperbolic and finite in number, and ii) the stable and unstable manifolds of the equilibrium points on quasi-stability boundaries satisfy the transversality condition. If x_{d} is a DDP on the quasi-stability boundary ∂Aₚ(xₛ), then there exists another one and only one SEP, says x̅ₛ, to which the unstable manifold of x_{d} converges. Conversely, if the set ∂Aₚ(xₛ)∩∂Aₚ (x̅ₛ) is nonempty, then the set contains a DDP.

Theorem 1.4 reveals a relationship between SEPs and DDPs. The unstable manifold of a DDP converges to two SEPs of the KKT dynamical system (E.8). In the context of optimization, Theorem 1.3 asserts that two neighboring critical points are connected by the unstable manifolds of the corresponding DDP. Note that the two conditions stated in Theorem 1.3 are generic properties for general nonlinear dynamical systems.

In the following, a numerical TT-IPM method is presented. Given a local optimal solution (e.g., xₛ⁰) and a set of search directions, The TT-IPM method computes tier-one local optimal solutions of xₛ⁰. Each tier-one local optimal solution is computed via computing the corresponding DDPs and then following the unstable manifold of each DDP and via carrying out IPMs.

TRUST-TECH Method for Computing Tier-One Local Optimal Solutions. Input: an initial local optimal solution xₛ⁰. Output: the set of tier-one local optimal solutions Vs of xₛ⁰. The following is the algorithm:

Step 1: Initialize the set of DDPs V_{d}= and the set of tier-one local optimal solutions Vₛ=.

Step 2: Define a set of search paths Sᵢ for xₛ⁰, i=1, 2, . . . , mⱼ, and set i=1.

Step 3: For each search path Sᵢ starting from xₛ⁰, compute its corresponding local optimal solution using the following steps:

i) Compute a DDP to the KKT dynamical system to find the corresponding DDP. If a DDP is found, proceed to the next step; otherwise, go to step vi).

ii) Letting the found DDP be denoted as x_{di}, check if it belongs to the set V_{d}, i.e., x_{di}∈V_{d}. If it does, go to step vi); otherwise, set V_{d}=V_{d} ∪{x_{di}} and proceed to the next step.

iii) Set x₀ᵢ=xₛ⁰+(1+ε)(x_{di}−xₛ⁰), where ε is a small number.

iv) Starting from x₀ᵢ, conduct a transitional search by integrating the KKT dynamical system to obtain the corresponding system trajectory until it reaches an interface point, say x_{fi}, at which IPMs outperforms the transitional search.

v) Starting from the interface point x_{fi} chosen in step iv), apply an IPM to find the corresponding local optimal solution with respect to x_{di}, denoted as xₛⁱ. And set Vₛ=Vₛ∪{xₛⁱ}.

vi) Set i=i+1 and repeat steps i) through vi) until i>mⱼ.

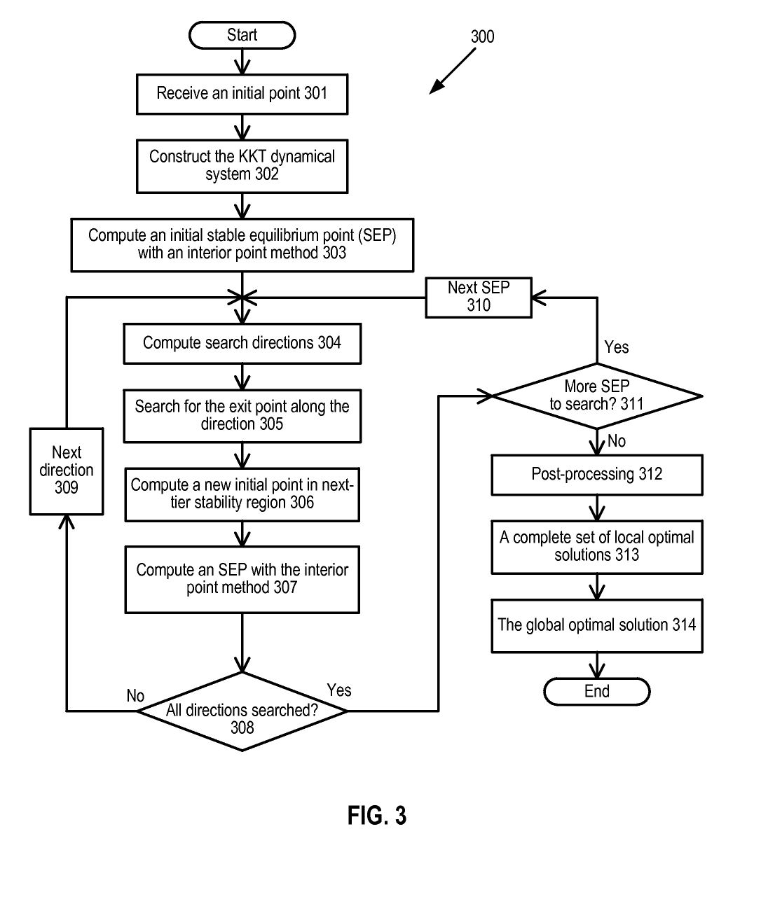

A TRUST-TECH Method for Computing All Local Optimal Solutions and the Global Optimal Solution. FIG. 3 illustrates a TT-IPM method 300 for computing local optimal solutions in multiple tiers according to one embodiment. Starting from an arbitrary initial point (e.g., xₛ⁰), the method 300 computes a complete set of local optimal solutions Vₛ as well as the global optimal solution to the constrained optimization problem (P.1).

The method 300 begins with receiving an initial point (block 301) and performing the following steps:

Step 0: Construct the KKT dynamical system associated with the constrained optimization problem (P.1) (block 302).

Step 1: Starting from x₀, apply an IPM to find a local optimal solution, i.e., xₛ⁰, to the constrained optimization problem (P.1), which is also an SEP of the constructed KKT dynamical system (block 303).

Step 2: Set j=0. Initialize the set of local optimal solutions Vₛ={xₛ⁰}, the set of tier-j local optimal solutions V_{new}^{j}={xₛ⁰}, and the set of found DDPs V_{d}=.

Step 3: Initialize the set of tier-(j+1) local optimal solutions V_{new}^{j+1}=.

Step 4: For each local optimal solution in V_{new}^{j} (e.g., find all of its tier-one local optimal solutions. The method 300 further includes the following sub-steps for Step 4:

(i) Compute a set of search paths Sᵢ^{j} for xₛ^{j}, i=1, 2, . . . , mⱼ and set i=1 (block 304). An exemplar search path can be a line originated from xₛ^{j}. In one embodiment, the set of search paths Sᵢ={±v₁, ±v₂, . . . , ±vₙ} includes all eigenvectors v₁, . . . , vₙ of the Jacobian matrix ∇F(xₛⁱ) of the KKT dynamical system computed at xₛⁱ. In another embodiment, the set of search directions Sᵢ={±v₁, ±v₂, . . . , ±vₙ} further includes random orthogonal directions, where each search path vᵢ is a random vector satisfying the orthogonal conditions, that is, ∥vᵢ∥=1 and vᵢ^{T}vⱼ=0, for all i≠j.

(ii) For each search path Sᵢ^{j} starting from xₛ^{j}, apply an effective method to nonlinear system (E.6) to find the corresponding exit point (block 305). An example of a method for finding the exit point can be the direct line search method. If an exit point is found, proceed to sub-step (iii); otherwise, go to sub-step (viii).

(iii) Denote the found DDP as x_{d,i}^{j}, check if it belongs to the set V_{d}, i.e., x_{d,i}^{j}∈V_{d}. If it does, go to sub-step (viii); otherwise, set V_{d}=V_{d}∪{x_{d,i}^{j}} and proceed to sub-step (iv).

(iv) Set x_{0,i}^{j}=xₛ^{j}+(1+ε)(x_{d,i}^{j}−xₛ^{j}), where ε is a small number (block 306).

(v) Starting from x_{0,i}^{j}, conduct a transitional search by integrating the KKT dynamical system to obtain the corresponding system trajectory until it reaches an interface point. x_{ƒ,i}^{j}, at which IPMs outperform the transitional search.

(vi) Starting from the interface point x_{ƒ,i}^{j} chosen in sub-step (v), apply an IPM to find the corresponding local optimal solution, denoted as x_{s,j}ⁱ (block 307).

(vii) Check if xₛⱼⁱ has been found before, i.e., x_{s,j}ⁱ ∈Vₛ. If it is a new local optimal solution, set Vₛ=Vₛ ∪{x_{s,j}ⁱ} and V_{new}^{j+1}=V_{new}^{j+1}∪{x_{s,j}ⁱ}.

(viii) Set i=i+1 (block 309) and repeat sub-steps (ii) through (viii) until i>mⱼ^{k} (i.e., all directions have been searched) (block 308).

Step 5: If the set of all newly computed local optimal solutions, namely V_{new}ⁱ, is empty (block 311), continue with Step 6; otherwise set j=j+1 (block 310) and go to Step 3.

Step 6 (block 312): Output the set of local optimal solutions Vₛ (block 313) and identify the best optimal solution from the set of Vₛ by comparing their corresponding objective function values and selecting the one with the smallest value. Output the smallest value as the global optimal solution (block 314).

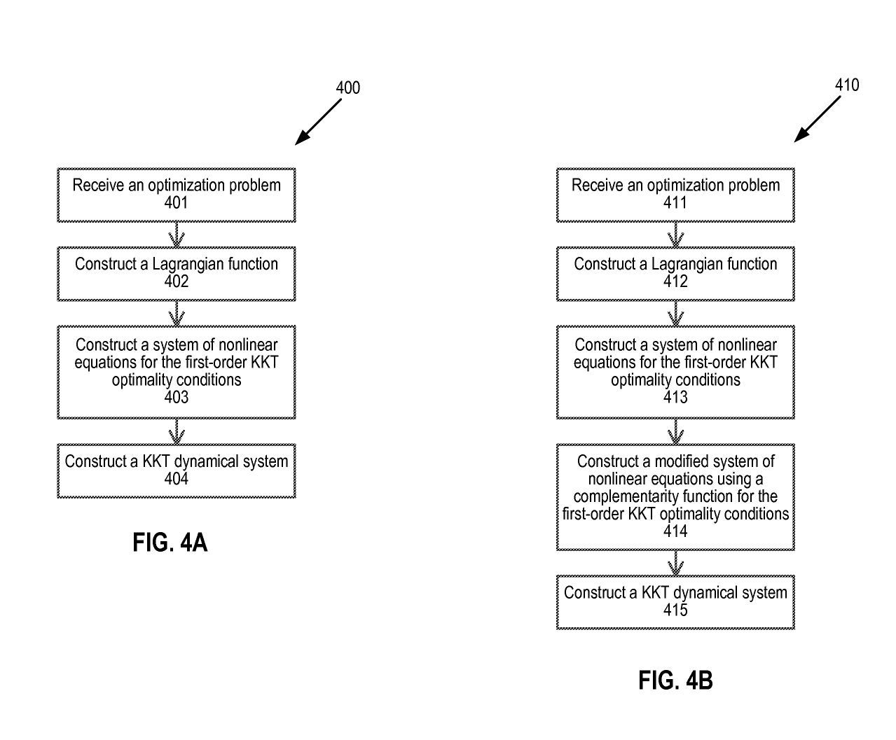

FIG. 4A and FIG. 4B illustrate two methods 400 and 410 for constructing the KKT dynamical system associated with the optimality conditions of the constrained nonlinear optimization problem. In one embodiment, referring to FIG. 4A, the method 400 includes the steps of:

Step 1: Receive the constrained nonlinear optimization problem (P.1) (block 401).

Step 2: Construct the penalized Lagrange function (E.4) with an augmented set of primal and dual variables (x, y, z, s, μ) (block 402).

Step 3: Construct the system of nonlinear equations (E.5) for the first-order KKT optimality conditions (block 403).

Step 4: Construct a KKT dynamical system associated with the optimality conditions of the constrained optimization problem (P.1) following the formulation (E.7) or the formulation (E.8) (block 404).

In another embodiment, referring to FIG. 4B, the method 410 includes the steps of:

Step 1: Receive the constrained nonlinear optimization problem (P.1) (block 411).

Step 2: Construct the penalized Lagrange function (E.4) with an augmented set of primal and dual variables (x, y, z, s, μ) (block 412).

Step 3: Construct the system of nonlinear equations (E.5) for the first-order KKT optimality conditions (block 413).

Step 4: Construct the modified system of nonlinear equations (E.6) using complementarity function for the first-order KKT optimality conditions (block 414).

Step 5: Construct the KKT dynamical system associated with the optimality conditions of the constrained optimization problem (P.1) following the formulation (E.7) or the formulation (E.8) (block 415).

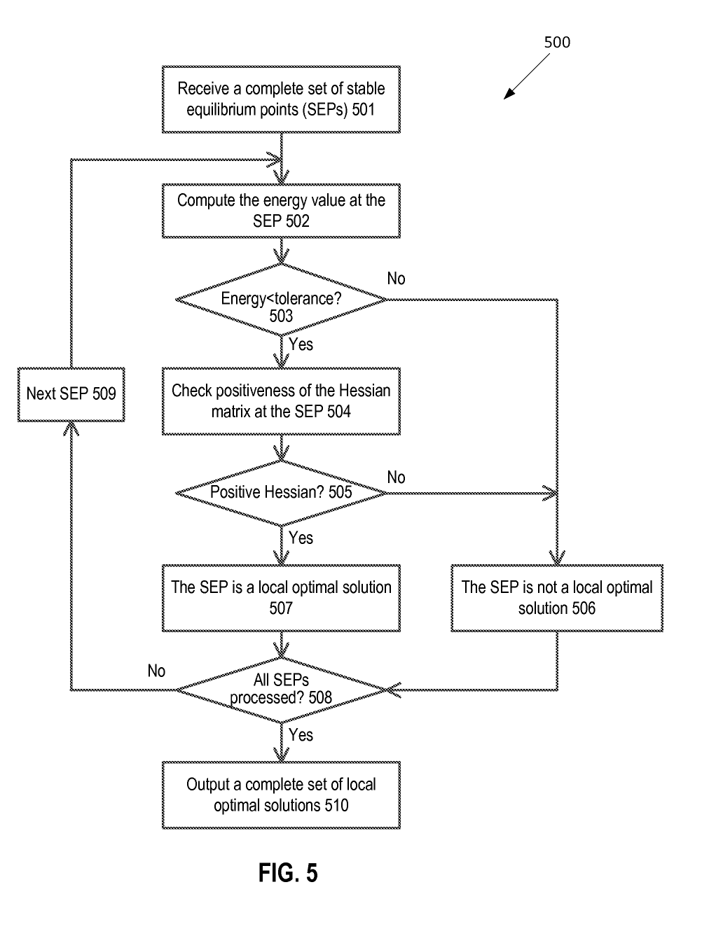

It is noted that not all SEPs of the KKT dynamical system correspond to local optimal solutions to the optimization problem (P.1). FIG. 5 illustrates a method 500 for identifying local optimal solutions from the set of SEPs according to one embodiment. The method 500 includes the following steps:

(a) Receive a complete set of SEPs, Vₛ={wₛⁱ=[xₛⁱ, λₛⁱ,sₛⁱ], i=1, . . . , K}, of the KKT dynamical system (E.6) associated with the optimization problem (P.1) (block 501).

(b) Initialize the set of local optimal solutions, Vₓ=, to the optimization problem (P.1), and set i=1.

(c) Compute the energy value E(wₛⁱ) at the SEP wₛⁱ and check the energy value of wₛⁱ (block 502).

(d) If E(wₛⁱ)<ε, where ε is a small number indicating the numerical tolerance for optimality (block 503), proceed to step (e); otherwise, the SEP wₛⁱ is not a local optimal solution to the optimization problem (P.1), proceed to step (g).

(e) Compute the Hessian matrix at the SEP wₛⁱ, and compute all eigenvalues of the Hessian matrix (block 504).

(f) If all eigenvalues of the Hessian matrix have positive real part (block 505), the SEP xₛⁱ is a local optimal solution, set Vₓ=Vₓ∪{xₛⁱ} and proceed to step (g). Otherwise, the SEP xₛⁱ is not a local optimal solution to the optimization problem (P.1), proceed to step (g).

(g) If i=K (block 508), proceed to step (h); otherwise, set i=i+1 (block 509) and proceed to step (c).

(h) Output the complete set of local optimal solutions Vₓ to the constrained nonlinear optimization problem (P.1) (block 510).

### A Numerical Example

The following example presents a procedure for computing a complete set of local optimal solutions to a 5-dimension optimization problem:

$${min}_{x ∈ {R}^{5}} f ( x ) = {( {x}_{1} - 1 )}^{2} + {( {x}_{1} - {x}_{2} )}^{2} + {( {x}_{2} - {x}_{3} )}^{3} + {( {x}_{3} - {x}_{4} )}^{4} + {( {x}_{4} - {x}_{5} )}^{4} \\ \begin{matrix} s . t . & {x}_{1} + {x}_{2}^{2} + {x}_{3}^{3} = 3 \sqrt{2} + 2 \\ & {x}_{2} - {x}_{3}^{2} + {x}_{4} = 2 \sqrt{2} - 2 \\ & {x}_{1} {x}_{5} = 2 \\ & - 5 \leq {x}_{i} \leq 5 , i = 1 , … , 5\end{matrix} . \qquad ( P .2 )$$

The procedure is an example of applying the method(s) of FIG. 3. Although a specific constrained nonlinear optimization problem is used in this example, it is understood that the procedure can apply to any constrained nonlinear optimization problems.

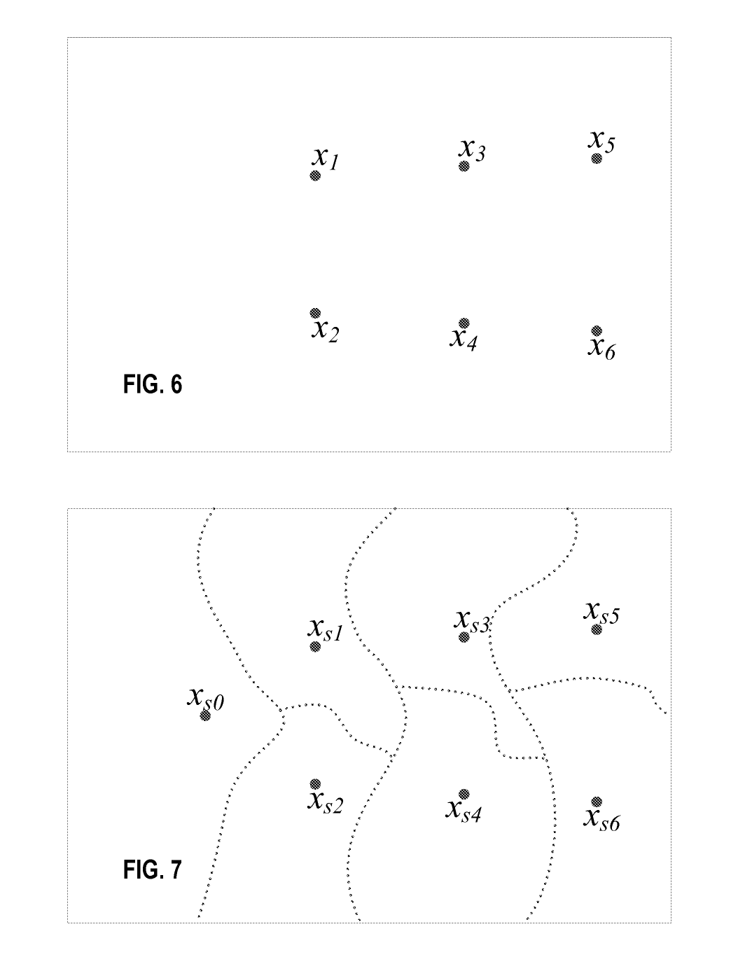

In this example, there are six local optimal solutions to (P.2), which are x₁ through x₆ illustrated in FIG. 6. In the associated KKT dynamical system of (P.2), six SEPs are identified, which are xₛ₁ through xₛ₆ illustrated in FIG. 7. Each SEP has its own stability region (the boundaries are illustrated as dotted curves in FIG. 7). The optimization problem (P.2) is solved using TT-IPM. The procedure for computing all local optimal solutions to the problem (P.2) is described as follows:

1) Set the initial point x₀=[0.0, 0.0, 0.0, 0.0, 0.0]^{T}, the objective function is ƒ(x₀)=1.0. This initial point is not feasible (the equality constraints are not satisfied).

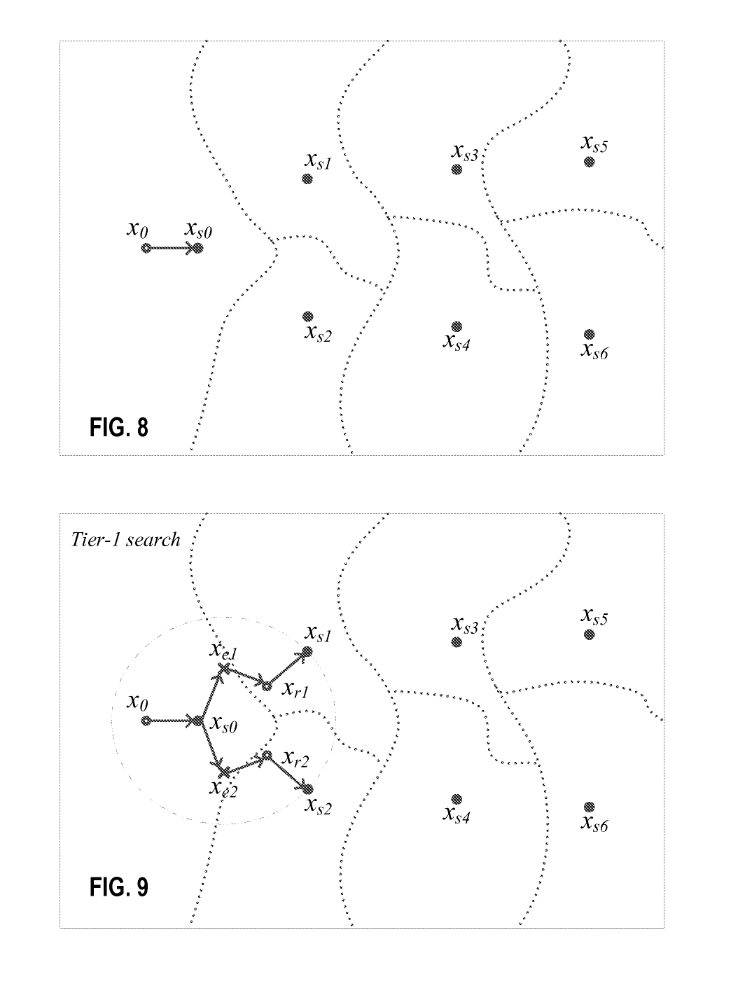

2) Using x₀ as the initial point, apply the IPM and attain a solution xₛ₀=[4.2798, −1.3675, 0.4528, 2.4010, 0.4673]^{T}. The KKT energy of this point is 31.7999 and its objective function ƒ(xₛ₀)=65.0048. This point is not an actual local optimal solution, since the KKT energy is not close to 0 (FIG. 8).

3) Tier-1 Search: Using xₛ₀ as the central point, search along different directions on the KKT energy surface and find exit points. Using the exit points as the initial conditions, apply the IPM to solve problem (E.8). Two new solutions are obtained, which are: (i) xₛ₁=[4.5696, −1.2522, 0.4718, 2.3032, 0.4377]^{T} with KKT energy being 4.7217×10⁻¹⁰ and ƒ(xₛ₁)=64.8719; (ii) xₛ₂=[0.7280, −2.2452, 0.7795, 3.6813, 2.7472]^{T} with KKT energy being 9.1276×10⁻¹³ and ƒ(xₛ₂)=52.9067. This process is illustrated in FIG. 9.

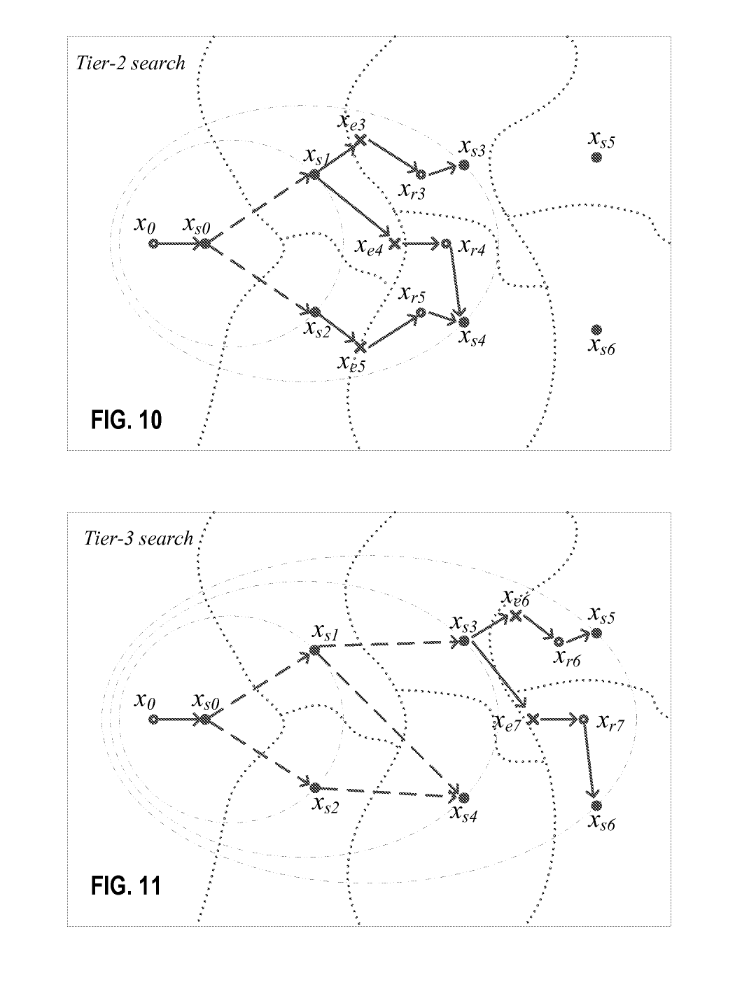

4) Tier-2 Search: Using xₛ₁ and xₛ₂ as the starting points, search along different directions on the KKT energy surface and find exit points. Using the exit points as the initial conditions, apply the IPM to solve problem (E.8). Two new solutions are obtained, which are: (i) xₛ₃=[1.1166, 1.2204, 1.5378, 1.9728, 1.7911]^{T} with KKT energy being 4.3324×10⁻¹⁵ and ƒ(xₛ₃)=0.0293; (ii) xₛ₄=[−2.7909, −3.0041, 0.2054, 3.8747, −0.7166]^{T} with KKT energy being 1.2552×10⁻⁷ and f(xₛ₄)=606.9965. This process is illustrated in FIG. 10.

5) Tier-3 Search: Using xₛ₃ and xₛ₄ as the central points, search along different directions on the KKT energy surface and find exit points. Using the exit points as the initial conditions, apply the IPM to solve problem (E.8). Two new solutions are obtained, which are: (i) xₛ₅=[−1.2731, 2.4104, 1.1949, −0.1542, −1.5710]^{T} with KKT energy being 8.9774×10⁻¹⁴ and ƒ(xₛ₅)=27.8730; (ii) xₛ₆=[−0.7034, 2.6357, −0.0964, −1.7980, −2.8434]^{T} with KKT energy being 1.7806×10⁻¹⁵ and ƒ(xₛ₆)=44.0225. This process is illustrated in FIG. 11.

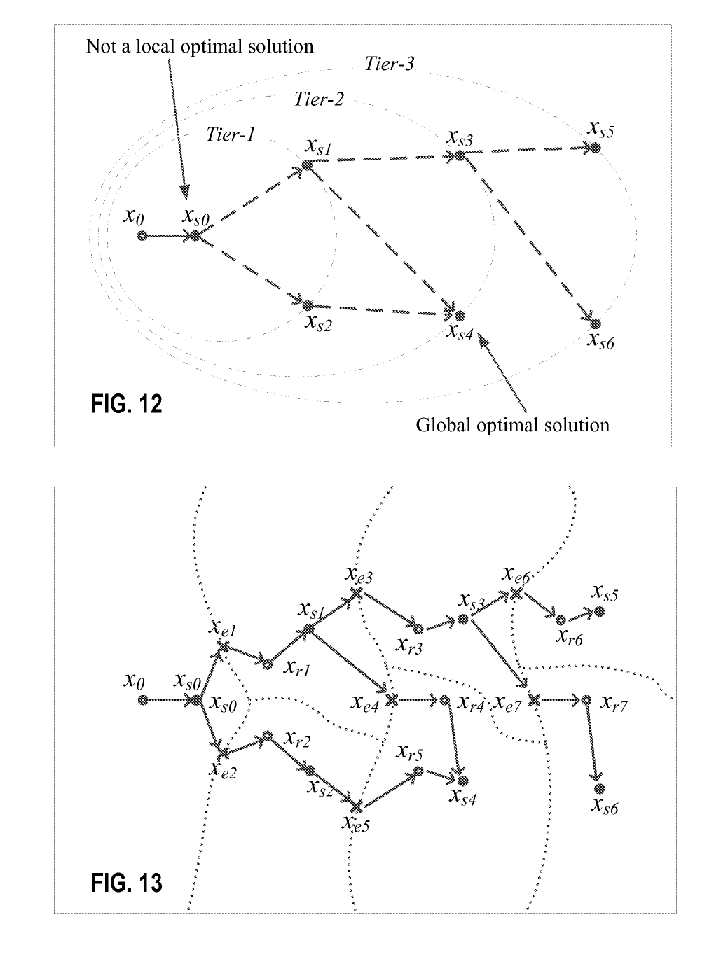

The entire procedure of FIG. 6-FIG. 11 for obtaining all local optimal solutions by TT-IPM is illustrated in FIG. 12, where SEPs, namely xₛ₀ through xₛ₆, have been found in three tiers of search, illustrated as tier-1, tier-2 and tier-3 search. Based on the KKT energy of each of the SEPs, it is determined that all six SEPs, namely xₛ₁ through xₛ₆, are local optimal solutions. The global optimal solution to the optimization problem (P.2), which is xₛ₄, is then identified among the local optimal solutions. FIG. 13 shows a schematic for the whole search process involving the exit points, namely xₑ₁ through xₑ₇ and the stability region points, namely xᵣ₁ through xᵣ₇.

The above example demonstrates the capability of the TT-IPM method and the following advantages of incorporating TRUST-TECH into the existing local optimization methods:

1) Local optimization methods, such as IPMs, can converge to a local optimal solution and can be entrapped in the local optimal solution.

2) Local optimization methods, such as IPMs, can sometimes converge to a point which is not a true local optimal solution.

3) The TT-IPM method integrates TRUST-TECH'S capability to locate multiple stability regions in the KKT dynamical system and IPM's capability to fast compute a local optimal solution, thus help local methods, such as IPMs, to escape from a local optimal solution and approach another local optimal solution.

TRUST-TECH based methods are valuable and can be of significant importance in the following sense: since a local method, such as IPMs, can only provide local optimal solutions in a restricted local region while a global method can only provide sparse approximated solutions within reasonable computational efforts, the TRUST-TECH based methods provide an enabling technology for:

(i) enhancing the functionality of local methods to find optimal solutions in a broader region, as described in the TT-IPM method;

(ii) enhancing the functionality of global methods to find global optimal solutions; and

(iii) providing flexibility in the integration of local and global methods to find global optimal solutions.

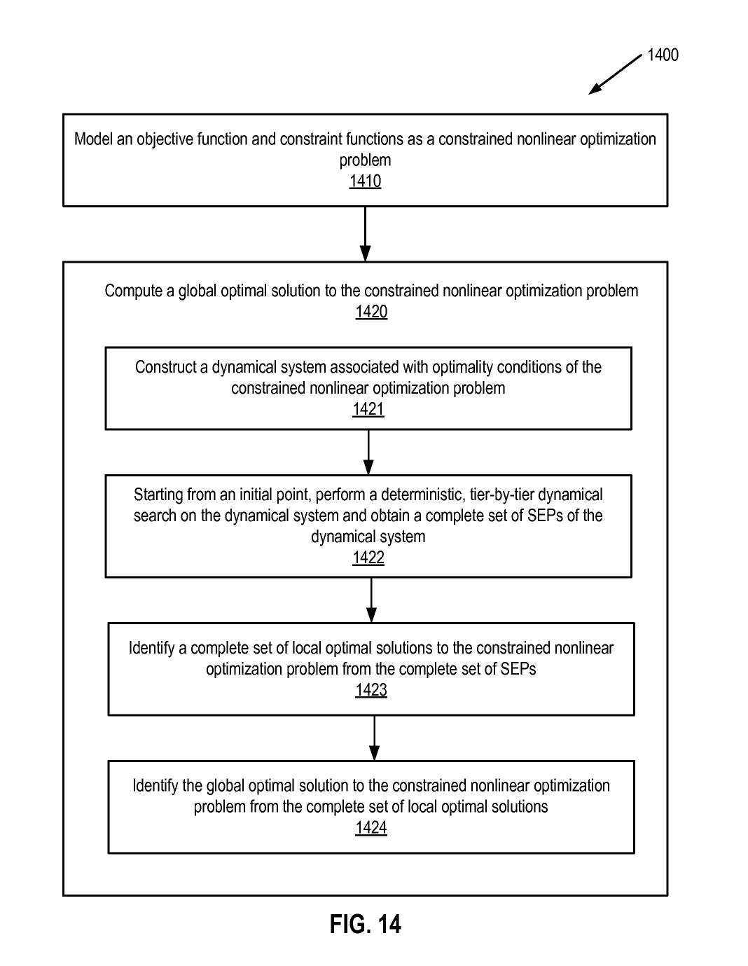

FIG. 14 is a flow diagram illustrating a method 1400 of an optimization system according to one embodiment of the invention. In one embodiment, the method 1400 may be performed by the optimization system for optimizing an objective function of an industrial system subject to a set of constraint functions. The method 1400 comprises: modeling the objective function and the constraint functions as a constrained nonlinear optimization problem (block 1410); and computing a global optimal solution to the constrained nonlinear optimization problem (block 1420). The step of computing further comprises the steps of: (a) constructing a dynamical system associated with optimality conditions of the constrained nonlinear optimization problem (block 1421); (b) starting from an initial point, performing a deterministic, tier-by-tier dynamical search on the dynamical system and obtaining a complete set of stable equilibrium points (SEPs) of the dynamical system (block 1422); (c) identifying a complete set of local optimal solutions to the constrained nonlinear optimization problem from the complete set of SEPs (block 1423); and (d) identifying the global optimal solution to the constrained nonlinear optimization problem from the complete set of local optimal solutions (block 1424).

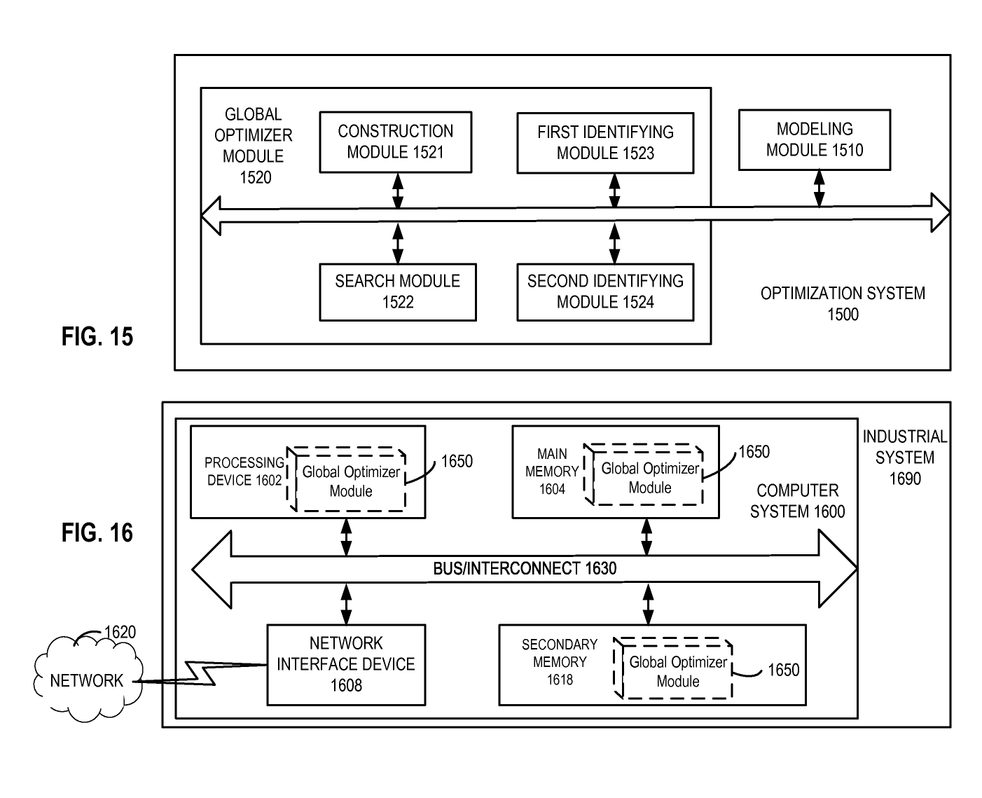

The method of FIG. 14 may be performed by hardware (e.g., circuitry, dedicated logic, programmable logic, microcode, etc.), software (e.g., instructions run on a processing device), or a combination thereof. In one embodiment, the method 1400 of FIG. 14 may be performed by a system such as the global optimizer module 100, a system 1500 of FIG. 15 and/or by a computer system 1600 of FIG. 16.

Embodiments of the methods disclosed herein may be implemented in hardware, software, firmware, or a combination of such implementation approaches. In one embodiment, the methods 200, 300, 400, 410, 500 and 1400 (FIG. 2, FIG. 3, FIG. 4A, FIG. 4B, FIG. 5 and FIG. 14) described herein may be performed by a processing system, such as the global optimizer module 100, an optimization system 1500 of FIG. 15 and/or by a computer system 1600 of FIG. 16. A processing system includes any system that has a processor, such as, for example; a digital signal processor (DSP), a microcontroller, an application specific integrated circuit (ASIC), or a microprocessor.

FIG. 15 is a block diagram illustrating an optimization system 1500 according to one embodiment of the invention. In one embodiment, the optimization system 1500 optimizes an objective function of an industrial system subject to a set of constraint functions. The optimization system 1500 comprises: a modeling module 1510 adapted to model the objective function and the constraint functions as a constrained nonlinear optimization problem; and a global optimizer module 1520 adapted to compute a global optimal solution to the constrained nonlinear optimization problem. The global optimizer module 1520 further comprises: a construction module 1521 adapted to construct a dynamical system associated with optimality conditions of the constrained nonlinear optimization problem; a search module 1522 adapted to, starting from an initial point, perform a deterministic, tier-by-tier dynamical search on the dynamical system and obtain a complete SEPs of the dynamical system; a first identifying module 1523 adapted to identify a complete set of local optimal solutions to the constrained nonlinear optimization problem from the complete set of SEPs; and a second identifying module 1524 adapted to identify the global optimal solution to the constrained nonlinear optimization problem from the complete set of local optimal solutions.

FIG. 16 illustrates a computer system 1600 according to one embodiment. The computer system 1600 may be a server computer, or any machine capable of executing a set of instructions (sequential or otherwise) that specify actions to be taken by that machine. While only a single machine is illustrated, the term “machine” shall also be taken to include any collection of machines (e.g., computers) that individually or jointly execute a set (or multiple sets) of instructions to perform any one or more of the methodologies discussed herein. In one embodiment, the computer system 1600 may be part of an industrial system 1690, such as an electrical power control system, a chemical plant design system, manufacturing system, a transportation scheduling system, a very-large-scale integration (VLSI) design system, a data mining system, a civil planning system, an investment portfolio management system or other industrial systems.

The computer system 1600 includes a processing device 1602. The processing device 1602 represents one or more general-purpose processors, or one or more special-purpose processors, or any combination of general-purpose and special-purpose processors. In one embodiment, the processing device 1602 is adapted to execute the operations of a global optimizer module 1650, which when executed causes the processing device 1602 to perform the functions of the global optimizer module 100 of FIG. 1 and the methods and/or procedures described in connection with FIGS. 2-5.

In one embodiment, the processing device 1602 is coupled, via one or more buses or interconnects 1630, to one or more memory devices such as: a main memory 1604 (e.g., read-only memory (ROM), flash memory, dynamic random access memory (DRAM), a secondary memory 1618 (e.g., a magnetic data storage device, an optical magnetic data storage device, etc.), and other forms of computer-readable media, which communicate with each other via a bus or interconnect. The memory devices may also different forms of read-only memories (ROMs), different forms of random access memories (RAMs), static random access memory (SRAM), or any type of media suitable for storing electronic instructions. In one embodiment, the memory devices may store the code and data of the global optimizer module 1650. In the embodiment of FIG. 16, the global optimizer module 1650 may be located in one or more of the locations shown as dotted boxes and labeled by the reference numeral 1650.

The computer system 1600 may further include a network interface device 1608. A part or all of the data and code of the global optimizer 100 may be transmitted or received over a network 1620 via the network interface device 1608. Although not shown in FIG. 16, the computer system 1600 also may include user input/output devices (e.g., a keyboard, a touchscreen, speakers, and/or a display).

In one embodiment, the global optimizer module 1650 can be implemented using code and data stored and executed on one or more computer systems (e.g., the computer system 1600). Such computer systems store and transmit (internally and/or with other electronic devices over a network) code (composed of software instructions) and data using computer-readable media, such as non-transitory tangible computer-readable media (e.g., computer-readable storage media such as magnetic disks; optical disks; read only memory; flash memory devices as shown in FIG. 16 as 1604 and 1618) and transitory computer-readable transmission media (e.g., electrical, optical, acoustical or other form of propagated signals such as carrier waves, infrared signals). A non-transitory computer-readable medium of a given computer system typically stores instructions for execution on one or more processors of that computer system. One or more parts of an embodiment of the invention may be implemented using different combinations of software, firmware, and/or hardware.

The operations of the methods and/or procedures described in connection with FIGS. 2-5 and 14 have been described with reference to the exemplary embodiments of FIGS. 1, 15 and 16. However, it should be understood that the operations of the methods and/or procedures of FIGS. 2-5 and 14 can be performed by embodiments of the invention other than those discussed with reference to FIGS. 1, 15 and 16, and the embodiments discussed with reference to FIGS. 1, 15 and 16 can perform operations different from those discussed with reference to the methods and/or procedures of FIGS. 2-5 and 14. While the methods and/or procedures of FIGS. 2-5 and 14 show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. A method performed by an optimization system for optimizing an objective function of an industrial system subject to a set of constraint functions, the method comprising the steps of:
modeling the objective function and the constraint functions as a constrained nonlinear optimization problem; and
computing a global optimal solution to the constrained nonlinear optimization problem, wherein the step of computing further comprises the steps of:
(a) constructing a dynamical system associated with optimality conditions of the constrained nonlinear optimization problem;
(b) starting from an initial point, performing a deterministic, tier-by-tier dynamical search on the dynamical system and obtaining a complete set of stable equilibrium points (SEPs) of the dynamical system;
(c) identifying a complete set of local optimal solutions to the constrained nonlinear optimization problem from the complete set of SEPs; and
(d) identifying the global optimal solution to the constrained nonlinear optimization problem from the complete set of local optimal solutions.

2. The method of claim 1, wherein the objective function and the constraint functions comprise twice-differentiable functions.

3. The method of claim 1, wherein the optimality conditions have a zero value at each one of the local optimal solutions.

4. The method of claim 1, wherein the dynamical system comprises a Karush-Kuhn-Tucker (KKT) dynamical system, and wherein the step (a) further comprises:
constructing a Lagrangian function; and
constructing a system of nonlinear equations for first-order KKT optimality conditions.

5. The method of claim 4, wherein constructing the first-order KKT optimality conditions further comprises constructing a modified system of nonlinear equations using a complementarity function for the first-order KKT optimality conditions.

6. The method of claim 5, wherein the dynamical system is formulated as \dot{w}=|F(w), wherein w is a vector of variables of the system of nonlinear equations, and F(w) is a function of the system of nonlinear equations or the modified system of nonlinear equations.

7. The method of claim 5, wherein the dynamical system is formulated as \dot{w}=−∇^{T}F(w)·F(w), wherein w is a vector of variables of the system of nonlinear equations, and F(w) is a function of the system of nonlinear equations or the modified system of nonlinear equations.

8. The method of claim 1, wherein the step (b) further comprises:
applying a local optimizer using the initial point to compute an initial SEP of the dynamical system, and wherein the local optimizer comprises an interior point method (IPM).

9. The method of claim 1, wherein the step (c) further comprises:
computing an energy value at each of the SEPs; and
based on the energy value, determining whether each of the SEPs is a candidate SEP for a local optimal solution.

10. The method of claim 9, wherein the step (c) further comprises:
forming a Hessian matrix at the candidate SEP;
computing eigenvalues of the Hessian matrix; and
determining whether the candidate SEP is the local optimal solution based on the eigenvalues.

11. The method of claim 1, wherein the step (b) further comprises:
performing the search in a set of search directions Sᵢ={±v₁, ±v₂, . . . , ±vₙ}, which include all eigenvectors v₁, . . . , vₙ of a Jacobian matrix of the dynamical system computed at xₛⁱ.

12. The method of claim 1, wherein the step (b) further comprises:
performing the search in a set of search directions Sᵢ={±v₁, ±v₂, . . . , ±vₙ}, which include random orthogonal directions.

13. A system for optimizing an objective function of an industrial system subject to a set of constraint functions, the system comprising:
a memory to store a global optimizer module; and
one or more processors coupled to the memory, the one or more processors adapted to execute operations of the global optimizer module to:
model the objective function and the constraint functions as a constrained nonlinear optimization problem; and
compute a global optimal solution to the constrained nonlinear optimization problem, wherein the one or more processor further adapted to:
(a) construct a dynamical system associated with optimality conditions of the constrained nonlinear optimization problem;
(b) start from an initial point, performing a deterministic, tier-by-tier dynamical search on the dynamical system and obtaining a complete set of stable equilibrium points (SEPs) of the dynamical system;
(c) identify a complete set of local optimal solutions to the constrained nonlinear optimization problem from the complete set of SEPs; and
(d) identify the global optimal solution to the constrained nonlinear optimization problem from the complete set of local optimal solutions.

14. The system of claim 13, wherein the dynamical system comprises a Karush-Kuhn-Tucker (KKT) dynamical system, and wherein the one or more processors are further adapted to:
construct a Lagrangian function; and
construct a system of nonlinear equations for first-order KKT optimality conditions.

15. The system of claim 14, wherein the one or more processors are further adapted to construct a modified system of nonlinear equations using a complementarity function for the first-order KKT optimality conditions.

16. The system of claim 15, wherein the dynamical system is formulated as \dot{w}=−F(w), wherein w is a vector of variables of the system of nonlinear equations, and F(w) is a function of the system of nonlinear equations or the modified system of nonlinear equations.

17. The system of claim 15, wherein the dynamical system is formulated as \dot{w}=−∇^{T}F(w)·F(w), wherein w is a vector of variables of the system of nonlinear equations, and F(w) is a function of the system of nonlinear equations or the modified system of nonlinear equations.

18. The system of claim 13, wherein the one or more processors are further adapted to apply a local optimizer using the initial point to compute an initial SEP of the dynamical system, and wherein the local optimizer comprises an interior point method (IPM).

19. The system of claim 13, wherein the one or more processors are further adapted to perform the search in a set of search directions Sᵢ={±v₁, ±v₂, . . . , ±vₙ}, which include all eigenvectors v₁, . . . , vₙ of a Jacobian matrix of the dynamical system computed at xₛⁱ.

20. The system of claim 13, wherein the one or more processors are further adapted to perform the search in a set of search directions Sᵢ={±v₁, ±v₂, . . . , ±vₙ}, which include random orthogonal directions.

21. A non-transitory computer readable storage medium including instructions that, when executed by a computer system, cause the computer system to perform a method for optimizing an objective function of an industrial system subject to a set of constraint functions, the method comprising the steps of:
modeling the objective function and the constraint functions as a constrained nonlinear optimization problem; and
computing a global optimal solution to the constrained nonlinear optimization problem, wherein the step of computing further comprises the steps of:
(a) constructing a dynamical system associated with optimality conditions of the constrained nonlinear optimization problem;
(b) starting from an initial point, performing a deterministic, tier-by-tier dynamical search on the dynamical system and obtaining a complete set of stable equilibrium points (SEPs) of the dynamical system;
(c) identifying a complete set of local optimal solutions to the constrained nonlinear optimization problem from the complete set of SEPs; and
(d) identifying the global optimal solution to the constrained nonlinear optimization problem from the complete set of local optimal solutions.
